(19) United States
(12) Patent Application Publication
(10) Pub. No.: US 2019/0278715 A1
(43) Pub. Date: Sep. 12, 2019

(54) SYSTEM AND METHOD FOR MANAGING DISTRIBUTION OF VIRTUAL MEMORY OVER MULTIPLE PHYSICAL MEMORIES

(71) Applicant: Nutanix, Inc., San Jose, CA (US)

(72) Inventors: Alexander J. Kaufmann, San Jose, CA (US); Gaurav Poothia, Redmond, WA (US); Igor Leonidovich Grobman, San Jose, CA (US); Malcolm Crossley, Cambridge (GB); Miao Cui, New York, NY (US)

(21) Appl. No.: 15/918,651

(22) Filed: Mar. 12, 2018

(51) Int. Cl. G06F 12/109; G06F 3/06

(52) U.S. Cl. CPC G06F 12/109; G06F 3/0604; G06F 3/0631; G06F 3/0664; G06F 3/067; G06F 2212/657; G06F 2212/1048; G06F 2212/151; G06F 2212/152; G06F 2212/154; G06F 2212/1008

(57) ABSTRACT

A system and method include managing, by a computing system, the memory assignments between a virtual and multiple physical memories based on deterministically realized distribution of the virtual memory over the multiple physical memories. The computing system can determine proportion values associated with the physical memories assigned to a virtual memory. The proportion values indicate the proportion of the total size of the memory allocated to the virtual memory is to be assigned to the physical memories.

### BACKGROUND 4

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, present day virtual computing systems still have limitations due to their configuration and the way they operate.

### SUMMARY

In accordance with at least some aspects of the present disclosure, a method is disclosed. The method includes identifying, by a computing system, a plurality of virtual processors and a plurality of virtual memories included in a virtual machine; identifying, by the computing system, a plurality of physical processors and a plurality of physical memories; determining, by the computer system, an insufficient memory condition indicated by a size of memory allocated to a first virtual memory of the plurality of virtual memories being greater than an available memory capacity of at least one physical memory of the plurality of physical memories; transmitting, by the computer system, responsive to the determining the insufficient memory condition, a request for memory assignment information to a management processor; receiving, by the computer system, from the memory management processor, memory assignment information including identities of at least two physical memories to be assigned to the first virtual memory and a proportion value associated with each of the at least two physical memories; assigning, by the computer system, each of the at least two physical memories to the first virtual memory; and distributing, by the computer system, the size of the memory allocated to the first virtual memory to the at least two physical memories based on their respective proportions.

In accordance with some other aspects of the present disclosure, a system is disclosed. The system manages a virtualization environment and includes a physical processing resource including a plurality of physical processors and a plurality of physical memories; a virtual machine including a plurality of virtual processors and a plurality of virtual memories; and a hypervisor. The hypervisor is configured to: identify a plurality of virtual processors and a plurality of virtual memories included in a virtual machine, identify a plurality of physical processors and a plurality of physical memories, determine an insufficient memory condition indicated by a size of memory allocated to a first virtual memory of the plurality of virtual memories being greater than an available memory capacity of at least one physical memory of the plurality of physical memories, determine, responsive to the determination of the insufficient memory condition, identities of at least two physical memories to be assigned to the first virtual memory and a proportion value associated with each of the at least two physical memories, assign each of the at least two physical memories to the first virtual memory, and distribute the size of the memory allocated to the first virtual memory to the at least two physical memories based on their respective proportions.

In accordance with some other aspects of the present disclosure, another method is disclosed. The method includes identifying, by a computing system, a plurality of virtual processors and a plurality of virtual memories included in a virtual machine; identifying, by the computing system, a plurality of physical processors and a plurality of physical memories; determining, by the computer system, an insufficient memory condition indicated by a size of memory allocated to a first virtual memory of the plurality of virtual memories being greater than an available memory capacity of at least one physical memory of the plurality of physical memories; determining, by the computer system, responsive to the determining the insufficient memory condition, identities of at least two physical memories to be assigned to the first virtual memory and a proportion value associated with each of the at least two physical memories; assigning, by the computer system, each of the at least two physical memories to the first virtual memory; and distributing, by the computer system, the size of the memory allocated to the first virtual memory to the at least two physical memories based on their respective proportions.

In accordance with some other aspects of the present disclosure, another system is disclosed. The system manages a virtualization environment and includes a physical processing resource including a plurality of physical processors and a plurality of physical memories; a virtual machine including a plurality of virtual processors and a plurality of virtual memories; and a hypervisor. The hypervisor is configured to: identify a plurality of virtual processors and a plurality of virtual memories included in a virtual machine, identify a plurality of physical processors and a plurality of physical memories, determine an insufficient memory condition indicated by a size of memory allocated to a first virtual memory of the plurality of virtual memories being greater than an available memory capacity of at least one physical memory of the plurality of physical memories, determine, responsive to the determination of the insufficient memory condition, identities of at least two physical memories to be assigned to the first virtual memory and a proportion value associated with each of the at least two physical memories, assign each of the at least two physical memories to the first virtual memory, and distribute the size of the memory allocated to the first virtual memory to the at least two physical memories based on their respective proportions.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 shows a block diagram of a node used in a virtual computing system, in accordance with some embodiments of the present disclosure.

FIG. 3 shows an example physical latency table that specifies latencies between physical processing cores and physical memory banks in the hardware resources of the node shown in FIG. 2, in accordance with some embodiments of the present disclosure.

FIG. 4 shows an example first memory assignment table that specifies assignment of virtual RAM banks in a virtual machine to physical RAM banks, in accordance with some embodiments of the present disclosure.

FIG. 5 shows an example second memory assignment table including proportions of assignment, in accordance with some embodiments of the present disclosure.

FIG. 6 shows a flow diagram of an example process for memory assignment, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to operating one or more virtual machines in a computing system including non-uniform memory access (NUMA) physical resource architecture. The NUMA architecture includes one or more physical processing nodes, where each physical processing node includes one or more physical processing cores and one or more physical memory banks. The physical processing cores can have non-uniform access times to the one or more memory banks. The virtual machines include at least one virtual processing node, where each virtual processing node includes virtual processing cores and virtual memory banks.

One technical problem encountered in such computing systems is the handling of memory allocation to virtual memories when the virtual memories cannot be fully assigned to a single physical memory. In such instances, more than one physical memory may be assigned to the virtual memory. That is, the memory allocated to the virtual memory is distributed among the assigned physical memories. However, some computer systems randomly or non-deterministically distribute the virtual memory over the assigned physical memories. This causes fragmentation of the virtual memory over the physical memory. Such fragmentation, can result in in-efficient utilization of the physical memory. The in-efficient utilization may in turn result in virtual memories being inefficiently allocated to the physical memories, thereby increasing the access time to the virtual memories. This increase in access time can in turn degrade the performance of the computing system.

The discussion below provides at least one technical solution to the technical problems mentioned above. For example, the computing system discussed below, a hypervisor can be used to manage the memory assignment between virtual and physical memory based on deterministically realized distribution of the virtual memory over the physical memory. In particular, the hypervisor, or a management process coupled to the hypervisor, can determine proportion values associated with the physical memories assigned to a virtual memory. The proportion values indicate the proportion of the total size of the memory allocated to the virtual memory is to be assigned to the physical memories. The proportion values can be selected such that the available capacity of the physical memories is efficiently utilized. This efficient utilization of the physical memories can result, for example, in improvement in the access times of the virtual memory to which the physical memories are assigned. This, in turn, can improve the speed and performance of the computer system.

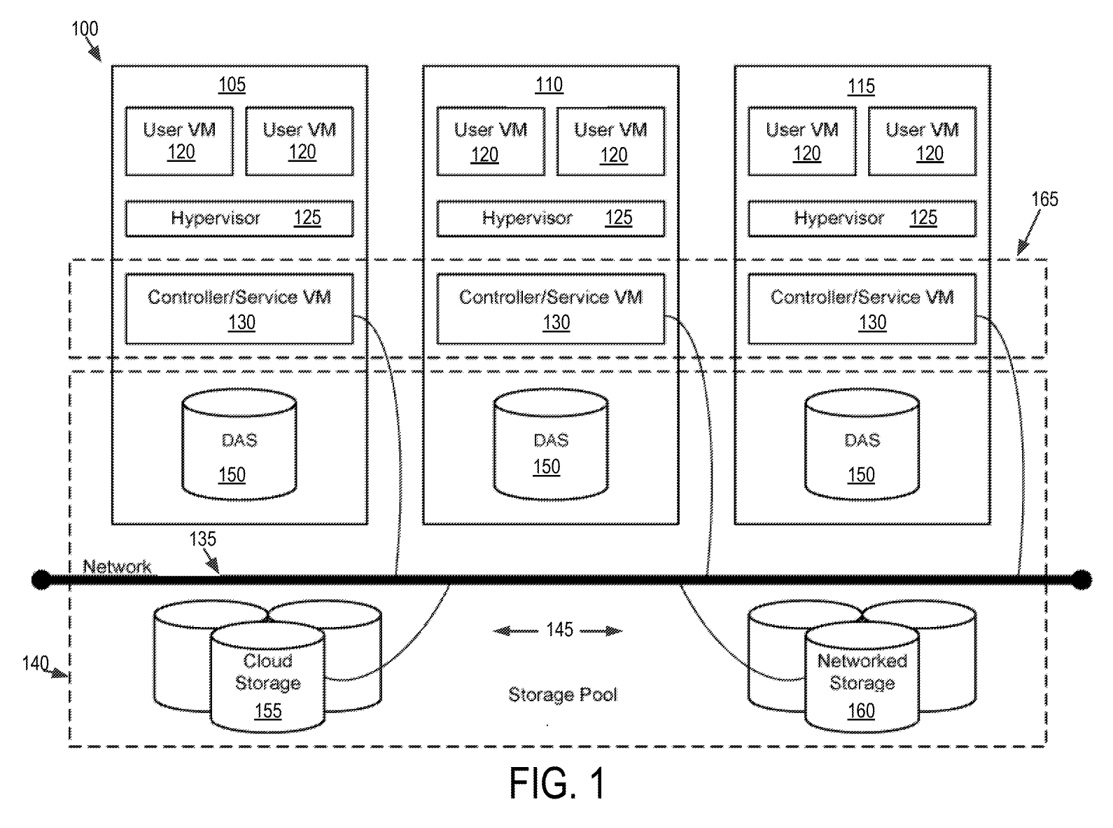

Referring now to FIG. 1, a virtual computing system 100 is shown, in accordance with some embodiments of the present disclosure. The virtual computing system 100 may be part of a datacenter. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater or fewer than three nodes may be used. Likewise, although only two of the user VMs 120 are shown on each of the first node 105, the second node 110, and the third node 115, in other embodiments, the number of the user VMs on the first, second, and third nodes may vary to include either a single user VM or more than two user VMs. Further, the first node 105, the second node 110, and the third node 115 need not always have the same number of the user VMs 120. Additionally, more than a single instance of the hypervisor 125 and/or the controller/service VM 130 may be provided on the first node 105, the second node 110, and/or the third node 115.

Further, in some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100.

Each of the first node 105, the second node 110, and the third node 115 may also be configured to communicate and share resources with each other via the network 135. For example, in some embodiments, the first node 105, the second node 110, and the third node 115 may communicate and share resources with each other via the controller/service VM 130 and/or the hypervisor 125. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120 that are part of a cluster may be configured to share resources with each other.

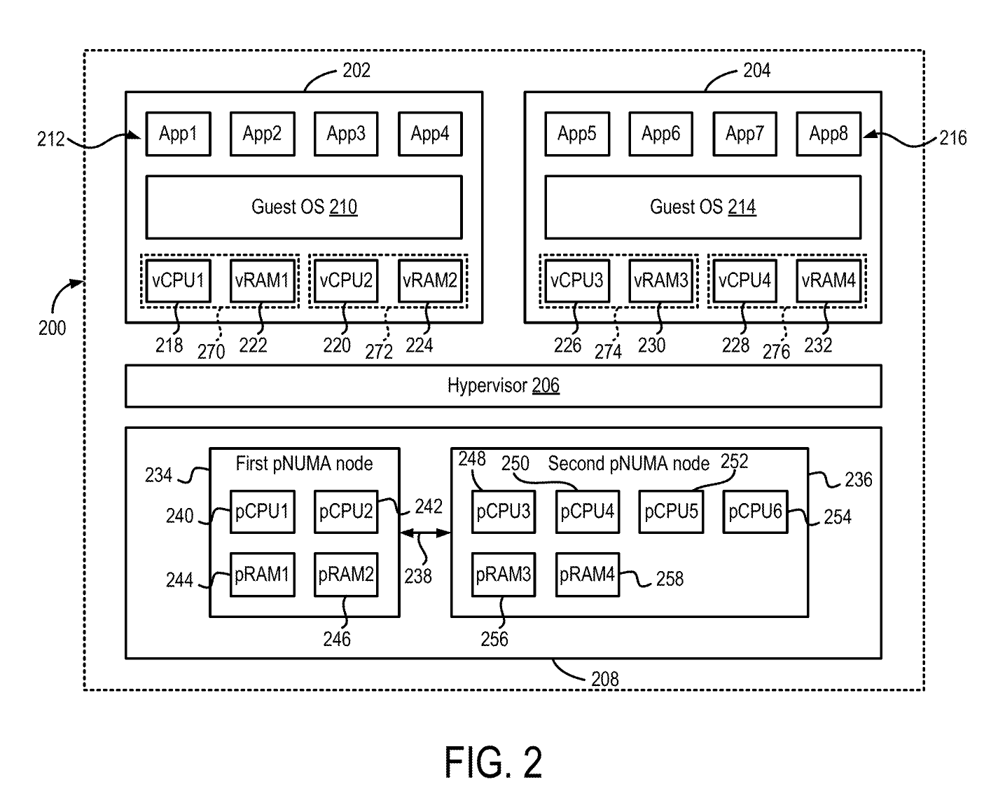

FIG. 2 shows a block diagram of a node 200 used in a virtual computing system, in accordance with some embodiments of the present disclosure. The node 200 shown in FIG. 2, for example, can be used to implement one or more of the first node 105, the second node 110, and the third node 115 discussed above in relation to FIG. 1. The node 200 includes a first user VM 202, a second user VM 204, a hypervisor 206, and physical hardware resources 208. The first user VM 202 and the second user VM 204 can be similar to the user VMs 120 discussed above in relation to FIG. 1. In addition, the first user VM 202 can include a first guest operating system (OS) 210 that can run a first set of software applications 212 (App1, App2, App3, and App4). Similarly, the second user VM 204 can include a second guest OS 214 that can run a second set of applications 216 (Apps, App6, App7, and App8). The number of software applications in the first and the second set of software applications 212 and 216 shown in FIG. 2 are only examples, and that the respective guest OSs may run fewer or more software applications.

The first user VM 202 also can include one or more virtual processors (vCPUs) and virtual memories (vRAMs) provided by the hypervisor 206. For example, the first user VM 202 can include a first virtual CPU (vCPU1) 218 and a second virtual CPU (vCPU2) 220, a first virtual RAM (vRAM1) 222, and a second virtual RAM (vRAM2) 224. Similarly, the second user VM 204 can include a third virtual CPU (vCPU3) 226, a fourth virtual CPU (vCPU4) 228, a third virtual RAM (vRAM3) 230, and a fourth virtual RAM (vRAM4) 232. The first guest OS 210 can run the first set of software applications 212 on one or more of the virtual CPUs and virtual RAMs included in the first user VM 202. Similarly, the second guest OS 214 can run the second set of software applications 216 on one or more of the virtual CPUs and the virtual RAMs included in the second user VM 204. In particular, the guest OSs can schedule threads associated with the respective software applications to the one or more respective virtual CPUs and assign memory space to the threads on the one or more respective RAMs.

The hypervisor 206 can implement processor and memory virtualization by abstracting the hardware resources 208 including processors, memory, and I/O devices, and present the abstraction to the first and the second user VMs 202 and 204 as the virtual CPUs and RAMs. For example, the hypervisor 206 can implement processor virtualization by scheduling time slots on one or more physical processors of the hardware resources 208 such that from the guest OS's perspective, the time slots are scheduled on the virtual CPUs. The hypervisor 206 can implement memory virtualization by maintaining a translation table that translates virtual memory addresses assigned by the guest OSs to physical memory addresses in the physical memories of the hardware resources 208.

The hardware resources 208 can include several processors and memories. While not shown in FIG. 2, the hardware resources may also include one or more I/O resources which can be virtualized and presented as virtual I/O resources to the first and the second user VMs 202 and 204. The processors and the memories in the hardware resources 208 are structured in a form that supports non-uniform memory access (NUMA) architecture. In particular, the hardware resources 208 can be structured as a physical NUMA (pNUMA). The pNUMA can include several NUMA nodes, such as first pNUMA node 234 and a second pNUMA node 236 interconnected by an interconnect 238. The hardware resources 208 can represent a multi-socket processing board where each socket corresponds to a pNUMA node, and each pNUMA node includes multiple processing cores. For example, the first pNUMA node 234 can have processor socket including two CPU cores pCPU1 240 and pCPU2 242, and two memory banks pRAM1 244 and pRAM2 246, while the second pNUMA node 236 can have a processor socket including four CPU cores pCPU3 248, pCPU4 250, pCPU5 252, and pCPU6 254 and two memory banks pRAM3 256 and pRAM4 258. Within each pNUMA node, the CPU cores can access the respective memory banks over a bus, a crossbar, or other interconnection technology. However, the CPU cores in each pNUMA node can access memory banks in other pNUMA cores. For example, the pCPU1 240 can access pRAM3 256 in the second pNUMA node 236 via the interconnect 238, which can be a system bus, a crossbar, or other interconnect technology. The access time for a CPU core in one NUMA node to access a memory bank in different NUMA node can be greater than the access time for the CPU core to access a memory bank within the same NUMA node. Similarly, based on how the CPU cores and memory banks are interconnected within a NUMA node, the access time of a CPU core to one memory bank within the NUMA node can be different from the access time to another memory bank in the same NUMA node. Thus, the access latencies within and across the NUMA nodes can be non-uniform.

The hypervisor 206 can advantageously use the non-uniform latencies between various pCPU cores and pRAM banks in the hardware resources 208 in processor and memory virtualization. In particular, the hypervisor 206 may map vCPUs to pCPUs and vRAMs to pRAMs based on the known latencies between the pCPUs and the pRAMs. For example, the hypervisor 206 may run critical applications on pCPUs and pRAMs pairs having the lowest latencies.

Referring again to the first user VM 202 and the second user VM 204, the virtual processors and the virtual memory within these virtual machines also can be structured in a non-uniform memory access architecture. For example, the hypervisor 206 can present the virtual machines a virtual NUMA (or vNUMA) architecture, where the various vCPUs and vRAMs are presented to the respective guest OS as being part of vNUMA nodes. For example, the hypervisor 206 can present the first guest OS 210 two vNUMA nodes, where the first vNUMA node 270 includes the vCPU1 218 and the vRAM1 222, while the second vNUMA node 272 includes the vCPU2 220 and the vRAM2 224. Similarly, the hypervisor 206 can be present the second guest OS 214 a third and fourth vNUMA nodes 274 and 276, where the third vNUMA node 274 includes the vCPU3 226 and the vRAM3 230, while the fourth vNUMA node 276 includes the vCPU4 228 and the vRAM4 232. The respective guest OSs, given the vNUMA architecture, can then schedule and map their respective applications based on the latencies between the various vCPUs and vRAMs provided by the hypervisor 206. The hypervisor 206 can maintain a physical latency table (also referred to as a physical system locality information table (pSLIT)) that specifies the latencies between any CPU core and a RAM bank.

It should be noted that the vNUMA and pNUMA architecture shown in FIG. 2 is only an example, and that other configurations are also within the scope of this disclosure. In one or more embodiments, each pNUMA node, such as the first pNUMA node 234 and the second pNUMA node 236 shown in FIG. 2, can include only a single pRAM per node, instead of the two pRAMs shown in FIG. 2. In such instances, several pCPU cores share the same pRAM bank and may have substantially equal latencies to that pRAM bank. Similarly, the vNUMA nodes may also include only a single vRAM instead of the two vRAMs shown in FIG. 2. In one or more embodiments, the vNUMA structure can mirror the pNUMA structure provided by the physical resources 208. For example, the number of vCPU cores and vRAM banks in a vNUMA node can be equal to the pCPU cores and pRAM banks in the pNUMA.

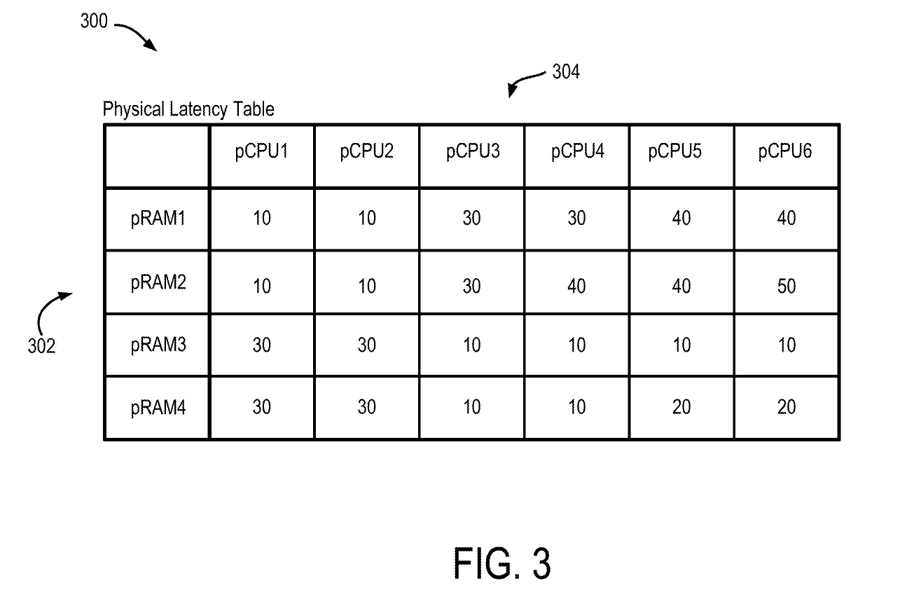

FIG. 3 shows an example physical latency table 300 that specifies latencies between physical CPU cores and physical RAM banks in the hardware resources 208. The physical latency table 300 includes four rows 302, each of the four rows corresponding to one of the four physical RAM banks: pRAM1 244, pRAM2 246, pRAM3 256, and pRAM4 258. The physical latency table 300 also includes six columns 304, each of the six columns corresponding to one of the six pCPU cores: pCPU1 240, pCPU2 242, pCPU3 248, pCPU4 250, pCPU5 252, and pCPU6 254. The physical latency table 300 specifies the latencies between pairs of physical CPU cores and physical RAM banks. For example, the latency for accessing the pRAM1 224 from the pCPU1 240 is 10, while the latency for accessing the pRAM1 244 from the pCPU5 252 is 40. The numbers representing latency are only examples, and can include units of time such as, for example, pico-seconds, nano-seconds, micro-seconds, etc. However, the latency may also be represented as a unit-less ratio. It should be understood that the latencies within the physical latency table 300 are based on the particular NUMA architecture, and can depend, in part, upon interconnect speeds between the CPU cores and the RAM banks in the hardware resources 208.

A similar latency table (also referred to as a virtual system locality information table (vSLIT)) can be maintained by the virtual machines specifying the access latencies between pairs of virtual CPUs and virtual RAM banks. For example, as discussed above, the hypervisor 206 can present to the first and second user VMs 202 and 204 a virtual NUMA architecture. In the virtual NUMA architecture, the hypervisor 206 can assign vCPUs cores and VRAM banks in the first and second user VMs 202 and 204 to pCPU cores and pRAM banks in the first pNUMA node 234 and the second pNUMA node 236. Based on the assignments of the vCPU cores and the vRAM banks to the pCPU cores and pRAMs, the first and second VMs 202 and 204 can maintain a virtual latency table specifying the access latencies between pairs of virtual CPUs and RAM banks based on the latencies specified in physical latency table 300.

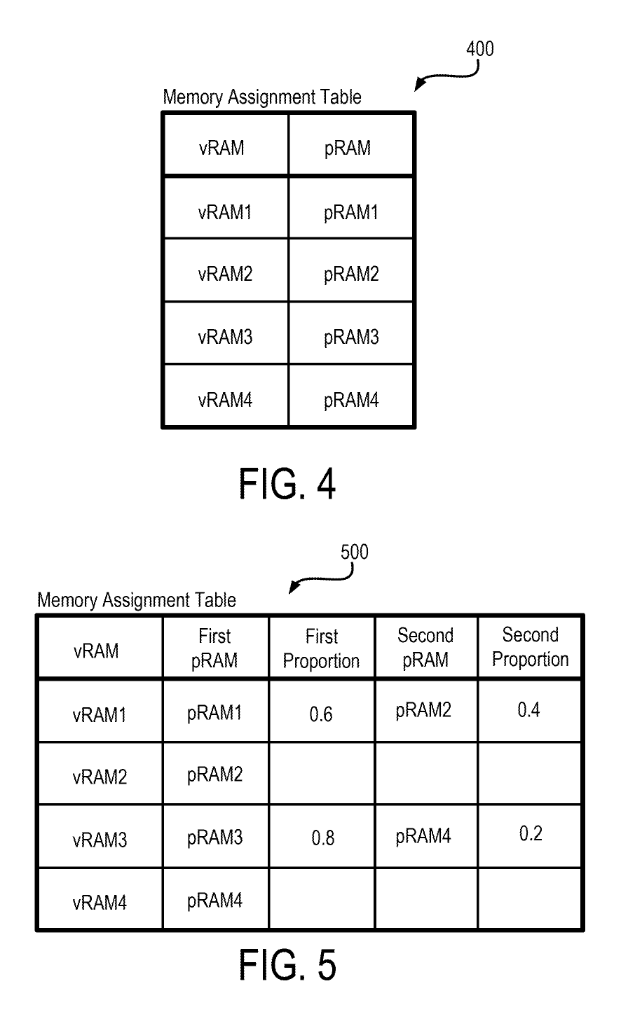

FIG. 4 shows an example first memory assignment table 400 that specifies assignment of virtual RAM banks in a virtual machine to physical RAM banks. In particular, the first memory assignment table 400 includes assignments of the vRAM banks of the first user VM 202 and the second user VM 204 to pRAM banks in the first pNUMA node 234 and the second pNUMA node 236. The first memory assignment table 400 can be maintained, for example, by the hypervisor 206. The first memory assignment table 400 can include two columns: one column listing all the vRAM banks and a second column listing all the pRAM banks to which the vRAM banks are assigned. For example, the vRAM1 222 is assigned to pRAM1 244, vRAM2 224 is assigned to pRAM2 246, vRAM3 230 is assigned to pRAM3 256, and vRAM4 232 is assigned to pRAM4 258. It is noted that the assignment shown in the first memory assignment table 400 is only an example, and that any vRAM bank in the first and the second user VMs 202 and 204 may be assigned to any pRAM bank in the first and second pNUMA nodes 234 and 236.

In some embodiments, the hypervisor 206 can generate or populate the first memory assignment table 400 when the first or the second user VMs 202 and 204 are first executed. For example, when the first user VM 202 is launched, the hypervisor 206 can determine that the first user VM 202 includes two vRAM banks: the vRAM1 222 and the vRAM2 224. Based on the determination, the hypervisor 206 can assign the two vRAM banks to one or more pRAM banks in the pNUMA nodes. In one or more embodiments, the hypervisor 206 may also consider the latencies discussed above in assigning the vRAM banks to the pRAM banks. For example, for lowest latency, the hypervisor 206 may assign the vCPU core and the vRAM bank of the same vNUMA node to a pCPU core and pRAM bank belonging to the same node.

The first memory assignment table 400 assumes that the each vRAM can be accommodated within the assigned pRAM. That is, the pRAM bank to which a vRAM is assigned, has sufficient memory space to accommodate the amount of memory allocated to the corresponding vRAM bank. For example, if vRAM1 222 were to be allocated 4 GB of memory, pRAM 1 has a size of at least 4 GB to accommodate the memory allocated to vRAM1 222. However this may not always be the case. In some instances, multiple vRAM banks are assigned to the same pRAM bank, which may result in the pRAM bank not having sufficient memory to fully accommodate the memory allocated to the assigned vRAM banks. For example, assume that the pRAM1 244 has a capacity of about 4 GB, and is assigned to vRAM1 222, to which about 3 GB have been allocated. As the capacity of the pRAM1 244 is greater than the memory allocated to vRAM1 222, the vRAM1 222 can be fully supported by the pRAM1 244. Now assume that the hypervisor 206 receives a request to assign a pRAM bank to vRAM2 224, which is also allocated with about 3 GB memory space. As pRAM1 244 is already assigned to vRAM1 222, and only has about 1 GB of space left, pRAM1 244 may not be able to fully accommodate the memory allocated to vRAM2 224. In some such instances, the hypervisor 206 may try to determine if any of the other pRAM banks can fully support the amount of memory allocated to vRAM2 224. If another pRAM bank is available with sufficient unused or unassigned capacity, then the hypervisor 206 can assign that pRAM to vRAM2 224. However there may be instances where none of the pRAM may alone be able to accommodate the vRAM2 224. For example, none of the pRAM1 244, pRAM2 246, pRAM3 256, or pRAM4 258 alone have sufficient unused or unassigned memory capacity to fully accommodate the 3 GB of memory allocated to vRAM2 224.

When none of the pRAMs can fully accommodate a vRAM, the hypervisor 206 may assign more than one pRAM to the vRAM. For example, responsive to determining that the vRAM2 224 cannot be fully accommodated by any pRAM, the hypervisor 206 may select two or more pRAMs, such as for example, pRAM1 244 and pRAM2 246, for assignment to the vRAM2 224. The hypervisor 206 can ensure that the sum of the unused or unallocated memory capacity in pRAM1 244 and pRAM2 246 is greater than the memory allocated to vRAM2 224.

The hypervisor 206 not only needs to determine the number of pRAMs to assign to the vRAM2 224, but also the proportion of the memory allocated to vRAM2 224 to assign to each of the assigned pRAMs. Some hypervisors may randomly, or in-deterministically assign portions of the memory of the vRAM to the assigned pRAMs. For example, some hypervisors may randomly assign 40% of the memory allocated to the vRAM to a first pRAM and the remaining 60% to a second pRAM, assuming that each pRAM can accommodate the assigned proportion of the memory allocated to the vRAM. However, randomly or in-deterministically generating the proportions may lead to fragmentation of the memory space in the pRAMs. In some instances, randomly or in-deterministically generating the proportions may lead to inefficient bin-packing. In particular, random or in-deterministically generated proportions may adversely affect future assignments of pRAMs to vRAMs. For example, the proportions and the assignments of pRAMs to vRAMs, can be deterministically selected to allow the most empty pRAM to remain unassigned. This approach can increase the likelihood of the pRAM being able to fully accommodate a large vRAM in the future. A random and in-deterministic approach would have randomly assigned vRAM to even the most vacant pRAM, thereby reducing the likelihood of that pRAM being able to fully accommodate a large vRAM in the future.

The hypervisor 206 provides the ability to select the proportion of the memory allocated to the vRAM bank to each assigned pRAM bank. In one or more implementations, the hypervisor 206 may receive the proportions from a management process running on the respective node (such as, for example, the first node 105 shown in FIG. 1). The hypervisor 206 can monitor the memory allocation of to the vRAMs and the available memory in the pRAMs, and determine that the memory allocated to at least one vRAIVI may have to be assigned to more than one pRAM. In some such instances, the hypervisor 206 may communicate with the management process to indicate that the vRAIVI memory allocation may have to be split, and request for the proportion with which to split the memory allocation. In some instances, the hypervisor 206 may also communicate to the management process the current capacity (or available memory) for each of the pRAMs and the memory allocated to each of the vRAMs in addition to current vRAM to pRAM assignments. The hypervisor 206 may subsequently receive information on the manner in which the memory allocated to a vRAM is to be distributed over pRAMs. For example, the received information can include the identities of the pRAMs to be assigned to the vRAM and the proportion of the memory allocated to the vRAM to be assigned to each identified pRAM. The hypervisor 206, based on the received information from the management process, can implement the assignment of the memory allocated to the vRAMs to the pRAMs. In one or more embodiments, the hypervisor 206 can implement and run a utility such as a proc file system, which can serve as an interface between the hypervisor 206 and the management process. The management process can use the utility to access and manipulate the hypervisor 206 registers and memory to enable communication between the hypervisor 206 and the management process.

FIG. 5 shows an example second memory assignment table 500 including proportions of assignment. The second memory assignment table 500 is similar to the first memory assignment table 400 shown in FIG. 4 in that like the first assignment table 400, the second assignment table also includes a column listing the vRAMs. The second memory assignment table 500 further includes a first pRAM column and a corresponding first proportion column, and a second pRAM column and a corresponding second proportion column. The second memory assignment table 500 indicates that the hypervisor 206 can assign vRAMs to up to two pRAMs. However, this is merely an example. It is understood that the second memory assignment table 500 may include additional columns associated with additional pRAMs and corresponding proportion columns. The hypervisor 206 may expand the second memory assignment table 500 as needed when additional pRAMs are used for assignment.

As shown in the second memory assignment table 500, two pRAMs, pRAM1 144 and pRAM2 246, are assigned to the vRAM1 222; one pRAM, pRAM2 is assigned to vRAM2 224; two pRAMs, pRAM3 256 and pRAM4 258, are assigned to vRAM3 230; and one pRAM, pRAM4 258, is assigned to vRAM4 232. Further, the vRAMs that have more than one pRAM assigned, include a proportion corresponding to each pRAM. For example, vRAM1 222 is assigned to pRAM1 244 with a 0.6 proportion and to pRAM2 with a 0.4 proportion. That is, 60% of the memory allocated to vRAM1 222 is assigned to pRAM1 244, while 40% is assigned to pRAM2 246. Similarly, with regard to the vRAM3 230, 80% of the memory allocated to the vRAM3 230 is assigned to pRAM3 256, while 20% is assigned to pRAM4 258. The vRAMs that have only one pRAM assigned, do not have any corresponding proportion values as the 100% of the memory allocated to the vRAM is assigned to the single pRAM. Of course, in some implementation, the proportion 1.0 may be included as a value of the proportion corresponding to the single pRAM.

In some embodiments, as discussed above, the proportions corresponding to the first pRAM and the second pRAM can be received from a management process. In some embodiments, the hypervisor 206 may determine the proportions, instead of, or in addition to, the proportions received from the management process. In some embodiments, the hypervisor 206 can determine the proportions based on a number of factors. For example, the factors can include the number of pRAMs available for assignment and their respective available memory capacities, and the amount of memory of the vRAM that is to be assigned. The factors can also include the access latencies associated with pNUMA nodes, such as those specified in a SLIT table (e.g., FIG. 3).

In some embodiments, the hypervisor 206 or a management process can determine the number and identities of the pRAMs and their corresponding proportions assigned to each vRAM such that the assignment can improve the efficiency of future pRAM assignments. For example, an assignment can be selected such that the likelihood of assigning the most vacant pNUMA is reduced. This can improve the likelihood of finding a single pRAM for assignment of large vRAMs received in the future. In another example, the hypervisor 206 or the management process may assign a set of pRAMs across multiple pNUMA nodes. In some such examples, the pRAMs from pNUMA nodes that have the lowest inter node access latency in the physical SLIT table can be selected. Thus, while the vRAM is fragmented across multiple pNUMA nodes, selecting pRAMs from low inter node latency pNUMAs can reduce the access time, and thereby improve the performance of the system. In yet another example, the hypervisor 206 or the management process can select pRAMs from those pNUMA nodes that have the most vacant capacity. Thus, while the vRAM is fragmented across multiple pNUMA nodes, the number of pNUMA nodes across which the vRAM is fragmented can be reduced.

In one or more embodiments, when a vRAM is fragmented across pRAMs belonging to multiple pNUMA nodes, the hypervisor 206 may also fragment the processing load across the pCPUs of the same multiple pNUMA nodes. In some such implementations, the hypervisor 206 can distribute the processing load across the pCPUs with the same proportion that is used to fragment the vRAMs over the pRAMs.

In some embodiments, the hypervisor 206 (or the management process) can dynamically update the second memory assignment table 500. For example, in some instances, the node 200 (FIG. 2) may install a new user VM, in addition to the first and the second user VMs 202 and 204, where the new user VM also includes a vNUMA architecture including one or more vRAMs. The hypervisor may have to assign pRAMs from the first and second pNUMA nodes 234 and 236 that have been currently assigned to the vRAIVIs of the first and the second user VMs 202 and 204. The hypervisor 206 can determine the desired memory allocation for each of the new vRAMs, and based on the number and the currently available memory in the pRAMs, assign the pRAMs (and the corresponding proportions) to the new vRAMs. In some other embodiments, the node my uninstall one or more user VMs, such that the pRAMs previously assigned to the vRAMs of the uninstalled user VM may have to be un-assigned, and their memory space be deallocated, and made available for assignment to other VMs if needed. The hypervisor 205 can re-determine the assignment of the pRAMs and the corresponding proportions based on the discussion above.

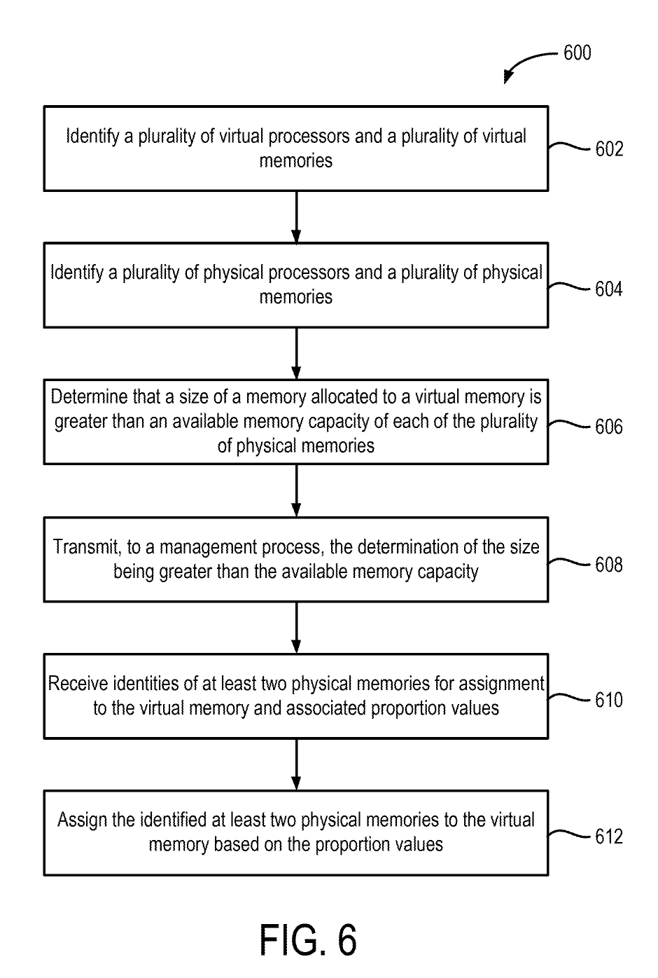

FIG. 6 shows a flow diagram of an example process 600 for memory assignment. Additional, fewer, or different operations may be performed depending on the implementation. In one or more embodiments, the process 600 can be executed by one or more processors at a node, such as nodes 105, 110, 115 (FIG. 1), and node 200 (FIG. 2). The process 600 includes identifying a plurality of virtual processors and a plurality of virtual memories (602). At least one example of this operation of process 600 has been discussed above in relation to FIGS. 1-5. In particular, as discussed above, the hypervisor 206 can identify the vCPU cores and the vRAM banks included in each of the first and the second user VM 202 and 204. In some embodiments, the first and second user VMs 202 and 204 can include the vCPUs and the vRAMs in a vNUMA architecture, where the vCPUs have non-uniform access times to the plurality of vRAIVIs.

The process 600 further includes identifying a plurality of physical processors and a plurality of physical memories (604). At least one example of this operation of the process 600 has been discussed above in relation to FIGS. 1-5. For example, the hypervisor 206 can identify a plurality of pCPU cores and a plurality of pRAM banks in the first and the second pNUMA nodes 234 and 236. The process 600 also includes determining that a size of a memory allocated to a virtual memory is greater than an available memory capacity of at least one physical memory of the plurality of physical memories (606). At least one example of this operation of the process 600 is discussed above in relation to FIGS. 1-5. For example, the hypervisor 206 can determine, for example, that the size of the memory allocated to vRAM1 222 is greater than the currently available capacity of at least one of the pRAMs in the first and the second pNUMA nodes 234 and 236. In some embodiments, the hypervisor 206 can determine that the size of the memory allocated to vRAM1 222 is greater than the currently available capacity of each of the pRAMs in the first and the second pNUMA nodes 234 and 236.

The process 600 further includes transmitting, to a management process, the determination of the size being greater than the available memory capacity (608). At least one example of this operation of process 600 is discussed above in relation to FIGS. 1-5. For example, the hypervisor 206 can transmit, to a management process, the determination that the size of the vRAM1 222 cannot be fully accommodated in any of the pRAMs in the first or second pNUMA nodes 234 and 236. The hypervisor 206 may also transmit the current memory capacity of each of the pRAMs and the size of the allocation of each of the vRAMs in the user VMs. The process 600 also includes receiving from the management process identities of at least two physical memories for assignment to the virtual memory and associated proportion values (610). At least one example of this operation of the process 600 is discussed above in relation to FIGS. 1-5. For example, the hypervisor can receive the identities of at least two pRAMs in the first and second pNUMA nodes 234 and 236 that can be assigned to the vRAM. For example, referring to the second memory assignment table 500 (FIG. 5), the hypervisor 206 can receive the identities of pRAM1 244 and pRAM2 246 as being assigned to the vRAM 222. Further, the hypervisor 206 also receives the proportion values of 0.6 and 0.4 associated with the pRAM1 244 and pRAM2 246, respectively.

The process 600 also includes assigning the identified at least two physical memories to the virtual memory based on the proportion values (612). At least one example of this operation of process 600 is discussed above in relation to FIGS. 1-5. For example, referring to the second memory assignment table 500 shown in FIG. 5, the hypervisor 206 can assign 60 percent of the size of the memory allocated to the vRAM1 222 to the pRAM1 244, and assign 40 percent of the size to the pRAM2 246.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1-2. (canceled)

3. The method of claim 27, wherein the first physical memory and the second physical memory are included in at least one physical Non-Uniform Memory Access (pNUMA) node.

4. The method of claim 23, wherein the virtual memory is included in at least one virtual Non-Uniform Memory Access (vNUMA) node.

5-13. (canceled)

14. The apparatus of claim 32, wherein the first physical memory and the second physical memory are included in at least one physical Non-Uniform Memory Access (pNUMA) node.

15. The apparatus of claim 28, wherein the virtual memory is included in at least one virtual Non-Uniform Memory Access (vNUMA) node.

16-19. (canceled)

20. The non-transitory computer readable medium of claim 37, wherein the first physical memory and the second physical memory are included in at least one physical Non-Uniform Memory Access (pNUMA) node.

21. The non-transitory computer readable medium of claim 33, wherein the virtual memory is included in at least one virtual Non-Uniform Memory Access (vNUMA) node.

22. (canceled)

23. A method comprising:
assigning, by a computer system, a virtual processor to a first physical processor;
assigning, by the computer system, a virtual memory to a first physical memory; and
in response to the assignments, adding, by the computer system, an entry to a data structure, wherein the entry indicates a latency between the virtual processor and the virtual memory.

24. The method of claim 23, the latency between the virtual processor and the virtual memory including a first latency between the first physical processor and the first physical memory.

25. The method of claim 23, the latency between the virtual processor and the virtual memory including a first latency between the virtual memory and the first physical memory.

26. The method of claim 23, further comprising determining, by the computer system, an insufficient memory condition indicated by a size of memory allocated to the virtual memory being greater than an available memory capacity of the first physical memory.

27. The method of claim 23, further comprising:
assigning, by the computer system, the virtual memory to a second physical memory; and
determining, by the computer system, a proportion value associated with the second physical memory; and
distributing, by the computer system, the virtual memory to the first physical memory and the second physical memory in accordance with the proportion value associated with the second physical memory.

28. An apparatus comprising a processor having programmed instructions to:
assign a virtual processor to a first physical processor;
assign a virtual memory to a first physical memory; and
in response to the assignments, add an entry to a data structure, wherein the entry indicates a latency between the virtual processor and the virtual memory.

29. The apparatus of claim 28, the latency between the virtual processor and the virtual memory including a first latency between the first physical processor and the first physical memory.

30. The apparatus of claim 28, the latency between the virtual processor and the virtual memory including a first latency between the virtual memory and the first physical memory.

31. The apparatus of claim 28, further comprising determining an insufficient memory condition indicated by a size of the virtual memory being greater than an available memory capacity of the first physical memory.

32. The apparatus of claim 28, the processor having further programmed instructions to:
assign the virtual memory to a second physical memory;
determine a proportion value associated with the second physical memory; and
distribute the virtual memory to the first physical memory and the second physical memory in accordance with the proportion value associated with the second physical memory.

33. A non-transitory computer readable storage medium to store a computer program configured to execute a method comprising:
assigning a virtual processor to a first physical processor;
assigning a virtual memory to a first physical memory; and
in response to the assignments, adding an entry to a data structure, wherein the entry indicates a latency between the virtual processor and the virtual memory including the virtual processor and the virtual memory.

34. The non-transitory computer readable storage medium of claim 33, the latency between the virtual processor and the virtual memory including a latency between the first physical processor and the first physical memory.

35. The non-transitory computer readable storage medium of claim 33, the latency between the virtual processor and the virtual memory including a first latency between the first physical processor and the first physical memory.

36. The non-transitory computer readable storage medium of claim 33, the latency of the virtual processor virtual memory pair including a first latency between the virtual memory and the first physical memory.

37. The non-transitory computer readable storage medium of claim 33, the method further comprising:
qassigning the virtual memory to a second physical memory; and
determining a proportion value associated with the second physical memory; and
distributing the virtual memory to the first physical memory and the second physical memory in accordance with the proportion value associated with the second physical memory.
